(19) United States
(12) Patent Application Publication
(10) Pub. No.: US 2012/0325866 A1
(43) Pub. Date: Dec. 27, 2012

(54) FLUID STORAGE TANK

(76) Inventors: Jin Hwan Lee, Ansan-si (KR); Sang Gwon Moon, Seoul (KR); Kwang Soo Park, Suwon-si (KR)

(21) Appl. No.: 13/583,194

(22) PCT Filed: Mar. 17, 2011
(86) PCT No.: PCT/KR2011/001865

§ 371 Date: Sep. 6, 2012

(30) Foreign Application Priority Data
Mar. 17, 2010 (KR) 20-2010-0002761

(51) Int. Cl. A47J 45/06; B67D 7/78; A47G 19/14

(52) U.S. Cl. 222/466; 220/772; 222/143; 222/465.1

(57) ABSTRACT

A fluid storage tank includes: a tank body in which a fluid is stored; and an ejection outlet that is formed on a top surface of the tank body in order to eject the fluid stored in the tank body, wherein the ejection outlet includes a tapered portion having an inner diameter that is increased upward away from the tank body. Accordingly, the fluid is prevented from being jiggled or splashed when being poured.

### TECHNICAL FIELD

This application claim the benefit of Korean Utility Model Application No. 10-2010-0002761, filed on Mar. 17, 2010, in the Korean Intellectual Property Office, the disclosure of which is incorporated herein in its entirety by reference.

The present device relates to a fluid storage tank, and more particularly, to a fluid storage tank that may prevent a fluid from being splashed or jiggled when the fluid is being ejected, and may be stably stacked when a plurality of the fluid storage tanks are stacked.

### BACKGROUND ART

In general, a fluid storage tank includes a tank body having an inner space in which a fluid is stored, an ejection outlet through which the stored fluid is ejected to the outside, and a handle that protrudes from a top surface of the tank body.

A conventional fluid storage tank 10 is illustrated in FIGS. 1 and 2. As shown in FIGS. 1 and 2, the conventional fluid storage tank 10 includes an ejection outlet 2 that is formed on a top surface of a tank body 1 having an inner space 4 in which a fluid is stored, and the stored fluid is ejected through the ejection outlet 2. A screw portion 5 is formed on the ejection outlet 2 so that a cover (not shown) for sealing the ejection outlet 2 may be coupled to the tank body 1. Also, a handle 3 used to hold the conventional fluid storage tank 10 when the conventional fluid storage tank 10 is moved or used is disposed on the top surface of the tank body 1.

However, as shown in FIG. 2, since the ejection outlet 2 of the conventional fluid storage tank 10 has a cylindrical shape with a constant inner diameter, when the fluid is poured by tilting the fluid storage tank 10, a flow rate at which the fluid is ejected through the ejection outlet 2 is rapidly increased. As a result, the ejected fluid is splashed in all directions, and it is difficult for a user to control the amount of fluid ejected through the ejection outlet 2.

Also, in order to easily pour a fluid, a passage for external air to be introduced into a fluid storage tank should be formed. In order to form the screw portion 5, a length of the cylindrical ejection outlet 2 of the conventional fluid storage tank 10 may not be reduced. As a result, since external air may not be easily introduced through the ejection outlet 2, the fluid stored in the conventional fluid storage tank 10 may be jiggled when being ejected.

Also, since the handle 3 is disposed only on the top surface of the tank body 1, it is difficult for the user to tilt the conventional fluid storage tank 10 while adjusting the center of gravity of the conventional fluid storage tank 10 without excessively bending their wrist. Also, since the handle 3 and the ejection outlet 2 protrude from the tank body 1, it is difficult to vertically stack a plurality of the conventional fluid storage tanks 10.

### DISCLOSURE OF INVENTION

### Solution to Problem

The present device provides a fluid storage tank that may prevent a fluid from being splashed or jiggled when the fluid is being poured.

### Advantageous Effects of Invention

Since the ejection outlet includes the tapered portion, a fluid may be prevented from being splashed or jiggled when being poured. Also, since the first groove having a size large enough for the handle to be inserted is formed in the bottom surface of the tank body, a plurality of the fluid storage tanks may be vertically stacked.

### BRIEF DESCRIPTION OF DRAWINGS

The above and other features and advantages of the present device will become more apparent by describing in detail exemplary embodiments thereof with reference to the attached drawings in which:

FIG. 1 is a cross-sectional view of a conventional fluid storage tank;

FIG. 2 is a cross-sectional view illustrating a case where a fluid is ejected from the conventional fluid storage tank of FIG. 1;

FIG. 3 is a perspective view of a fluid storage tank according to an embodiment of the present device;

FIG. 4 is a bottom view of the fluid storage tank of FIG. 3;

FIG. 5 is a cross-sectional view of the fluid storage tank of FIG. 3;

FIG. 6 is a cross-sectional view illustrating a case where a fluid is ejected from the fluid storage tank of FIGS. 3; and

FIG. 7 is a cross-sectional view illustrating a case where a plurality of the fluid storage tank of FIG. 3 are vertically stacked.

### BEST MODE FOR CARRYING OUT THE INVENTION

The present device provides a fluid storage tank that may prevent a fluid from being splashed or jiggled when the fluid is being poured.

According to an aspect of the present device, there is provided a fluid storage tank including: a tank body in which a fluid is stored; and an ejection outlet that is formed on a top surface of the tank body in order to eject the fluid stored in the tank body, wherein the ejection outlet includes a tapered portion having an inner diameter that is increased upward away from the tank body.

The fluid storage tank may further include: a handle that protrudes from the top surface of the tank body; and a first groove that is formed in a bottom surface of the tank body and has a size large enough for the handle to be inserted into the first groove.

The fluid storage tank may further include a second groove that is formed in the bottom surface of the tank body and has a size large enough for a tank cover for sealing the ejection outlet to be inserted into the second groove.

The fluid storage tank may further include an auxiliary handle that is disposed on a side surface of the tank body.

### MODE FOR THE INVENTION

The present device will now be described more fully with reference to the accompanying drawings, in which exemplary embodiments of the device are shown.

The device may be embodied in different forms and should not be construed as limited to the embodiments set forth herein. In the same embodiment, the same name and the same reference numeral denote the same element.

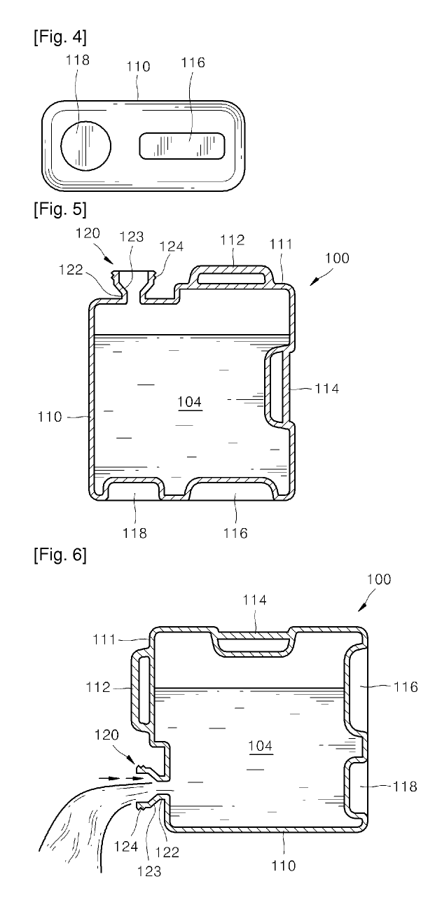

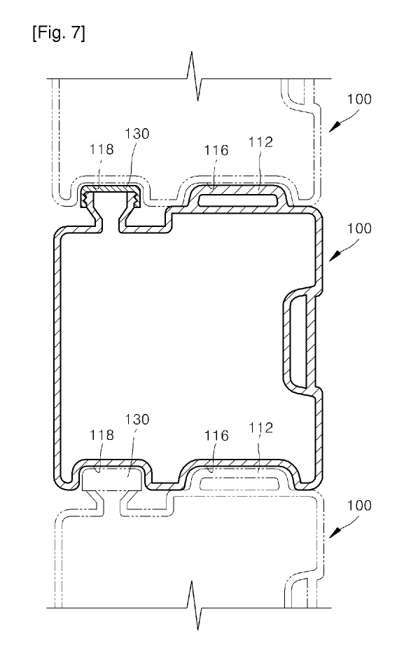

FIG. 3 is a perspective view of a fluid storage tank 100 according to an embodiment of the present device. FIG. 4 is a bottom view of the fluid storage tank 100 of FIG. 2. FIG. 5 is a cross-sectional view of the fluid storage tank 100 of FIG. 3. FIG. 6 is a cross-sectional view illustrating a case where a fluid is ejected from the fluid storage tank 100 of FIG. 3. FIG. 7 is a cross-sectional view illustrating a case where a plurality of the fluid storage tank 100 of FIG. 3 are vertically stacked.

Referring to FIGS. 3 and 5, the fluid storage tank 100 includes a tank body 110 having an inner space 104, and an ejection outlet 120 formed on a top surface 111 of the tank body 100 in order to eject a fluid, e.g., a liquid sauce, stored in the tank body 110 to the outside. Also, a handle 112 used by a user to hold the fluid storage tank 100 when the fluid storage tank 100 is moved or used protrudes from the top surface 111 of the tank body 110.

The ejection outlet 120 includes a neck portion 122 connected to the tank body 110, a screw portion 124 having a thread so that a tank cover 130 for sealing the ejection outlet 120 may be coupled to the tank body 110, and a tapered portion 123 disposed between the neck portion 122 and the screw portion 124 and having an inner diameter that is increased upward away from the tank body 110.

As shown in FIG. 6, since an inner diameter of the ejection outlet 120 is increased due to the tapered portion 123, a cross-sectional area of a passage through which a fluid is ejected is increased. As a result, since a flow rate at which the fluid is ejected is reduced at the tapered portion 123, the fluid may be prevented from being splashed in all directions, and the fluid may be easily poured while the user adjusts the amount of fluid ejected through the ejection outlet 120. Also, since a length of the neck portion 122 may be reduced by additionally providing the screw portion 124, external air may be more easily introduced into the fluid storage tank 100 when the fluid is poured by tilting the fluid storage tank 100. Accordingly, the fluid may be prevented from being jiggled in the fluid storage tank 100, and the fluid may be easily ejected through the ejection outlet 120.

Meanwhile, an auxiliary handle 114 is disposed on a side surface of the fluid storage tank 100. When the user pours a fluid by tilting the fluid storage tank 100, the user may more easily pour the fluid by using the auxiliary handle 114 instead of the handle 112 disposed on the top surface 111 of the tank body 110 or by using both the handle 112 and the auxiliary handle 114.

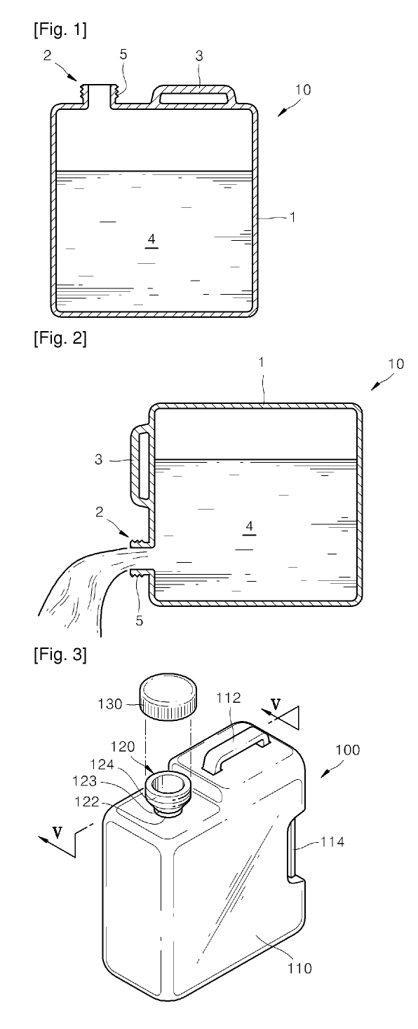

As described above, since a handle 3 is disposed only on a top surface of a tank body 1 in a conventional fluid storage tank 10 of FIG. 1, when a user tilts the conventional fluid tank 10 in order to pour a fluid, the users wrist is excessively bent. As a result, the user may not be able to stably hold the conventional fluid storage tank 10, and as the fluid is ejected, the user may fail to pour the fluid while appropriately adjusting the center of gravity of the conventional fluid storage tank 10. Accordingly, it is difficult for the user to control the amount of fluid ejected from the conventional fluid storage tank 10.

Meanwhile, since the auxiliary handle 114 is disposed on the fluid storage tank 100 of FIG. 6, when pouring a fluid, the user may adjust an angle at which the fluid storage tank 100 is tilted by holding the handle 112 disposed on the top surface 111 of the tank body 110 with one hand to fix the fluid storage tank 100 and by holding the auxiliary handle 114 disposed on the side surface of the tank body 110 with the other hand. Since the user may be able to naturally hold the fluid storage tank 100, the user may pour the fluid while controlling the fluid storage tank 100 to eject a desired amount of the fluid without excessive stress applied to the users wrist.

Meanwhile, as shown in FIGS. 4 and 5, a first groove 116 having a size large enough for the handle 112 disposed on the top surface 111 of the tank body 110 to be inserted and a second groove 118 having a size large enough for the tank cover 130 for sealing the ejection outlet 120 to be inserted are formed in a bottom surface of the fluid storage tank 100.

That is, the first groove 116 has a depth that is greater than a height of the handle 112 formed on the top surface 111 of the fluid storage tank 100, a width that is greater than a width of the handle 112, and a length that is greater than a length of the handle 112. Also, the second groove 118 has a depth that is greater than a height of the tank cover 130, and an inner diameter that is greater than an outer diameter of the tank cover 130.

Accordingly, as shown in FIG. 7, when a plurality of the fluid storage tanks 100 are vertically stacked, the handle 112 disposed on the top surface 111 of one lower fluid storage tank 100 may be inserted into the first groove 116 of one upper fluid storage tank 100, and the tank cover 130 of the lower fluid storage tank may be inserted into the second groove 118 of the upper fluid storage tank.

As such, since the first groove 116 and the second groove 118 are disposed in the bottom surface of the fluid storage tank 100, when a plurality of the fluid storage tanks 100 are vertically stacked, adjacent fluid storage tanks may be stacked even though the handle 112 protrudes from the tank body 110. Accordingly, a storage space, e.g., a warehouse, in which the plurality of fluid storage tanks 100 are stored, may be reduced, and the fluid storage tanks 100 may be efficiently carried to another place by being stably stacked.

Although the first groove 116 and the second groove 118 are formed in the bottom surface of the fluid storage tank 100 in the embodiments, the second groove 118 may be omitted as long as the tank cover 130 is not higher than the top surface 111 of the tank body 110.

Also, although the ejection outlet 120 includes the neck portion 122 in the embodiments, the ejection outlet 120 may have a shape that is tapered from the tank body 110 without including the neck portion 122.

As described above, since the ejection outlet 120 includes the tapered portion 123, a fluid may be prevented from being splashed or jiggled when being poured. Also, since the first groove 116 having a size large enough for the handle 112 to be inserted is formed in the bottom surface of the tank body 110, a plurality of the fluid storage tanks 100 may be vertically stacked.

While the present device has been particularly shown and described with reference to exemplary embodiments thereof, it will be understood by those of ordinary skill in the art that various changes in form and details may be made therein without departing from the spirit and scope of the present device as defined by the following claims.

1. A fluid storage tank comprising:
a tank body in which a fluid is stored; and
an ejection outlet that is formed on a top surface of the tank body in order to eject the fluid stored in the tank body,
wherein the ejection outlet comprises a tapered portion having an inner diameter that is increased upward away from the tank body.

2. The fluid storage tank of claim 1, further comprising:
a handle that protrudes from the top surface of the tank body; and
a first groove that is formed in a bottom surface of the tank body and has a size large enough for the handle to be inserted into the first groove.

3. The fluid storage tank of claim 2, further comprising a second groove that is formed in the bottom surface of the tank body and has a size large enough for a tank cover for sealing the ejection outlet to be inserted into the second groove.

4. The fluid storage tank of claim 1, further comprising an auxiliary handle that is disposed on a side surface of the tank body.

5. The fluid storage tank of claim 2, further comprising an auxiliary handle that is disposed on a side surface of the tank body.

6. The fluid storage tank of claim 3, further comprising an auxiliary handle that is disposed on a side surface of the tank body.
